(19) United States
(12) Patent Application Publication
(10) Pub. No.: US 2014/0136405 A1
(43) Pub. Date: May 15, 2014

(54) SYSTEMS AND METHODS FOR PROCESSING OF PERSON-TO-PERSON ELECTRONIC PAYMENTS

(71) Applicant: MASTERCARD INTERNATIONAL INCORPORATED, Purchase, NY (US)

(72) Inventors: Brian J. DuCharme, London (GB); Shawn Hagmeier, St. Peters, MO (US)

(73) Assignee: MASTERCARD INTERNATIONAL INCORPORATED, Purchase, NY (US)

(21) Appl. No.: 13/678,344

(22) Filed: Nov. 15, 2012

(51) Int. Cl. G06Q 20/22

(52) U.S. Cl. CPC G06Q 20/22
USPC 705/40; 705/39

(57) ABSTRACT

A computer system for use with a memory device for facilitating person-to-person electronic payments from a payor to an account associated with a payee is provided. A payee account identifier and a payee identifier are stored in the memory device. The payor submits a request for a transfer of funds from a payor account to the payee account. The request includes the amount of funds to be transferred, a payor account identifier to indicate the source of funds, and the payee identifier. The payee identifier includes a telephone number, and in particular, a mobile telephone number associated with the payee.

### BACKGROUND OF THE INVENTION

The field of the invention relates generally to systems and methods for electronic payment, and more particularly to network-based systems and methods for processing of electronic payments from person to person.

Known electronic payment systems enable users to send and receive payments (for example, payments for bills) electronically. Initially, a user must identify a potential biller to the system. Typically, in known systems, the user identifies a potential payee by name and by a payee zip code. For example, the user may have a paper bill that the user desires to pay electronically. Using the payee name and remittance address on the paper bill, the user identifies the payee to the system. Known systems compare the payee name and zip code to payees that are known to the system. More particularly, known systems may maintain a database of payees that includes information on how to transfer payments to the payee electronically, e.g., using EFT. In addition, some known bill payment systems use a payment network, such as the MasterCard® Network, to transfer payments from users to payees (MasterCard is a registered trademark of MasterCard International, of Purchase, N.Y.).

It would be desirable to provide a system and method for facilitating electronic payments between individuals that would take advantage of such existing payment systems.

### BRIEF DESCRIPTION OF THE INVENTION

In one embodiment, a computer-implemented method for facilitating person-to-person electronic payments from a payor to at least one account associated with a payee is provided. The method is implemented using a computer device coupled to a memory device. The method includes storing in the memory device a payee account identifier and a payee identifier associated therewith, the payee account identifying the at least one account associated with the payee, the payee identifier including a telephone number. The method further includes receiving from the payor a request for a transfer of funds from an account associated with the payor to the at least one account associated with the payee, wherein the request includes a transfer amount, a payor account identifier, and the payee identifier. The method further includes retrieving from the memory device the payee account identifier based on the request. The method further includes electronically transferring the transfer amount from the payor account to the at least one payee account.

In another embodiment, a computer system, including a processor and a computer-readable storage device having encoded thereon computer readable instructions that are executable by the processor, for facilitating person-to-person electronic payments from a payor to at least one account associated with a payee, is provided. The computer-executable instructions cause the processor to store in the memory device a payee account identifier and a payee identifier associated therewith, wherein the payee account identifies the at least one account associated with the payee, and the payee identifier includes a telephone number. The computer-executable instructions further cause the processor to receive from the payor a request for a transfer of funds from an account associated with the payor to the at least one account associated with the payee, wherein the request includes a transfer amount, a payor account identifier, and the payee identifier. The computer-executable instructions further cause the processor to retrieve from the memory device the payee account identifier based on the request. The computer-executable instructions further cause the processor to electronically transfer the transfer amount from the payor account to the at least one payee account.

In yet another embodiment, at least one non-transitory computer-readable storage media having computer-executable instructions embodied thereon, for facilitating person-to-person electronic payments from a payor to at least one account associated with a payee, is provided. When executed by at least one processor, the computer-executable instructions cause the processor to store in the memory device a payee account identifier and a payee identifier associated therewith, wherein the payee account identifies the at least one account associated with the payee, and the payee identifier includes a telephone number. The computer-executable instructions further cause the processor to receive from the payor a request for a transfer of funds from an account associated with the payor to the at least one account associated with the payee, wherein the request includes a transfer amount, a payor account identifier, and the payee identifier. The computer-executable instructions further cause the processor to retrieve from the memory device the payee account identifier based on the request. The computer-executable instructions further cause the processor to electronically transfer the transfer amount from the payor account to the at least one payee account.

### BRIEF DESCRIPTION OF THE DRAWINGS

FIG. 1 is a schematic diagram illustrating an exemplary multi-party payment card industry system for enabling ordinary payment-by-card transactions.

FIG. 2A is a simplified block diagram of a conventional electric financial service system.

FIG. 2B is a further depiction of the conventional electronic financial service system shown in FIG. 2A.

FIG. 3 is a simplified block diagram of an exemplary embodiment of a server architecture of a system in accordance with one embodiment of the present invention.

FIG. 4 is an expanded block diagram of an exemplary embodiment of a server architecture of a system in accordance with one embodiment of the present invention.

FIG. 5 is a simplified diagram of a person-to-person payment environment in accordance with one embodiment of the present invention.

FIG. 6 is a flowchart of an exemplary method for making a person-to-person payment in accordance with one embodiment of the present invention.

### DETAILED DESCRIPTION OF THE INVENTION

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

The embodiments described herein relate to electronic financial transactions, particular to facilitating person-to-person payments. Described in detail herein are exemplary embodiments of systems and processes that facilitate person-to-person electronic payments from a payor to an account associated with a payee. A technical effect of the systems and processes described herein include at least one of (a) storing in the memory device a payee account identifier and a payee identifier associated therewith, the payee account identifying the at least one account associated with the payee, the payee identifier including a telephone number; (b) receiving from the payor a request for a transfer of funds from an account associated with the payor to the at least one account associated with the payee, wherein the request includes a transfer amount, a payor account identifier, and the payee identifier; (c) retrieving from the memory device the payee account identifier based on the request; (d) electronically transferring the transfer amount from the payor account to the at least one payee account; (e) receiving the at least one of the payee account identifier and the payee identifier from one of the payee and the payor; (f) prompting the payor to identify one of the plurality of payee accounts into which funds are to be transferred; (g) storing a plurality of payee account identifiers corresponding to the plurality of payee accounts; (h) storing a discrete payee identifier associated with a respective one of each of the plurality of payee accounts; and (i) registering the payee in a biller directory for receiving payments electronically.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The systems and processes are not limited to the specific embodiments described herein. In addition, components of each system and each process can be practiced independent and separate from other components and processes described herein. Each component and process also can be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

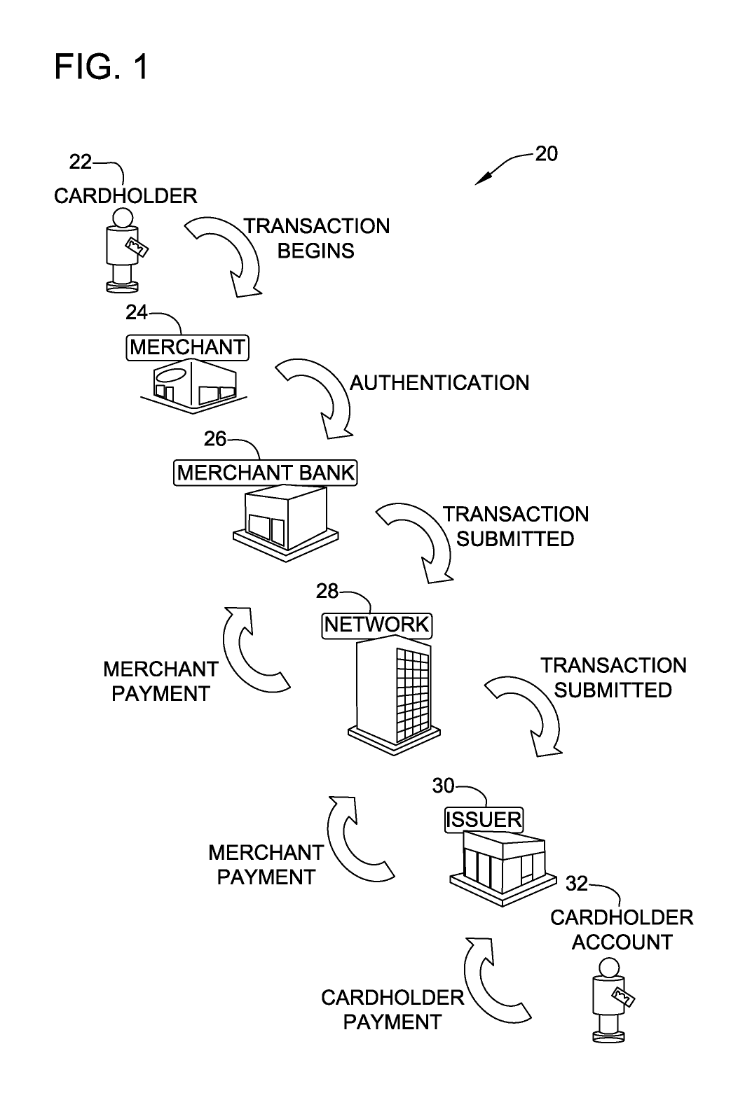

FIG. 1 is a schematic diagram 20 illustrating an exemplary multi-party payment card industry system for enabling ordinary payment-by-card transactions in which historical transactions are utilized at least in part with an ensemble aggregate merchant prediction system. As utilized herein, aggregate merchant refers to a high level grouping of merchant locations. More specifically, the various individual merchant locations for a retailer are aggregated together (e.g., linked to one another in a database) to form an aggregate merchant. One merchant location is therefore a component of an aggregate merchant. Typically, an aggregate merchant is utilized when referring to a chain of stores and locations are aggregated together, as further described herein, based on a number of field values stored in a database of transaction data.

The present invention relates to a payment card system, such as a credit card payment system using the MasterCard® interchange. The MasterCard® interchange is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical payment card system, a financial institution called the “issuer” issues a payment card, such as a credit card, to a consumer, who uses the payment card to tender payment for a purchase from a merchant. To accept payment with the payment card, the merchant must normally establish an account with a financial institution that is part of the financial payment system. This financial institution is usually called the “merchant bank” or the “acquiring bank” or “acquirer bank.” When a consumer 22 tenders payment for a purchase with a payment card (also known as a financial transaction card), the merchant 24 requests authorization from the merchant bank 26 for the amount of the purchase. The request may be performed over the telephone, but is usually performed through the use of a point-of-sale terminal, which reads the consumer's account information from the magnetic stripe on the payment card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor.”

Using the interchange 28, the computers of the merchant bank or the merchant processor will communicate with the computers of the issuer bank 30 to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account 32 is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which transactions are settled as a group. Data that is associated with such transactions, as described further herein, is utilized in the art of predicting future purchasing activities.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

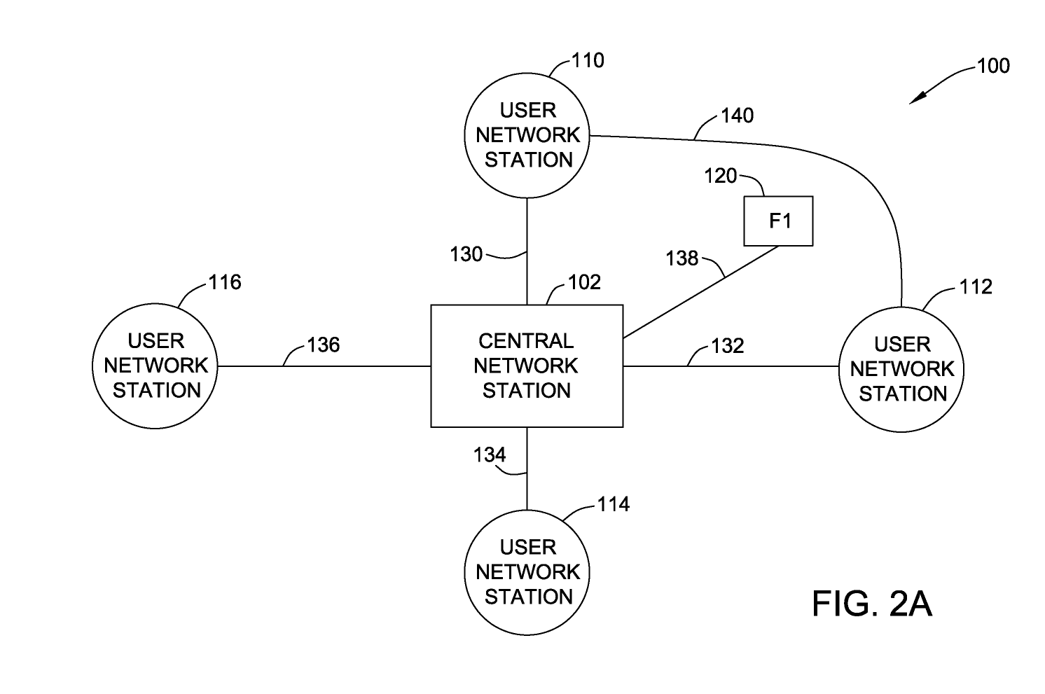

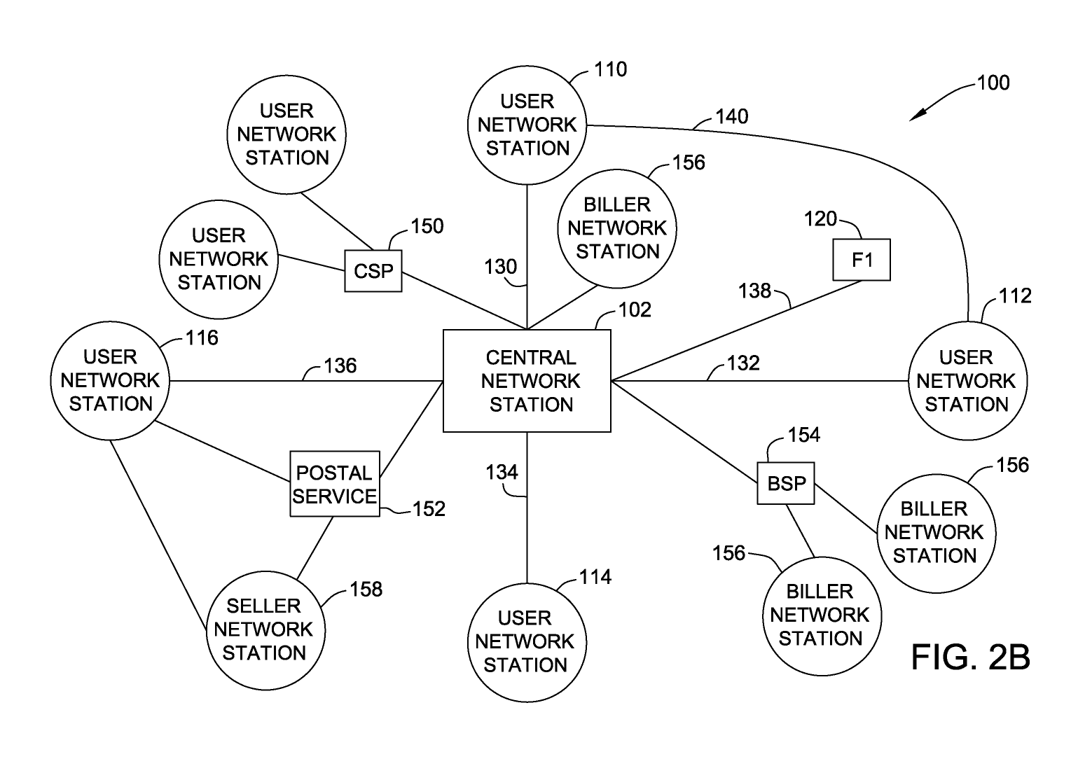

FIG. 2A is a generalized exemplary depiction of a conventional electronic financial service network 100. In a most basic form, such a network typically comprises a central network station 102 in communication with multiple user network stations 110, 112, 114, 116. Network users, who are customers of the financial service network 100, direct the central network station 102 to perform or facilitate financial transactions and/or services on their behalf. These directions are made via user network stations 110-116. A user network station is typically a personal computer, though it could be another type device. Another type device could be, but is not limited to, a telephone, a personal digital assistant, a set top box, or a computing device even more powerful than a personal computer. The financial transactions and services typically include, but are not limited to, bill and/or invoice presentment, bill and/or invoice payment, investment services, person-to-person payments, transmissions of financial information, home banking transactions, and purchase transactions. The central network station 102 conventionally maintains a central repository of information relating to services and transactions performed and/or facilitated and disseminates portions of this information to and between respective participants in the network 100, including those associated with user network stations 110-116 as well as other participants to be discussed below. In providing and/or facilitating some electronic financial services, the central network station 102 causes funds to move among and between deposit accounts associated with various ones of the network users and a deposit account associated with the central network station 102 maintained at a financial institution (FI) 120. Additionally, other types of accounts are often used to move funds, such as stored value accounts and credit accounts.

Each of the user network stations 110-116 communicates with the central network station 102 via a communication link 130, 132, 134, 136 and 138. A communication link can be established via, but is not limited to, conventional dial-up phone service, wireless phone service, including digital, analog and hybrid systems, an intranet, an extranet, a LAN, a WAN, and the Internet. Additionally, two or more of the user network stations 110-116 often communicate directly with one another via a communication link. For example, as shown in FIG. 2A, user network stations 110 and 112 communicate with one another via communication link 140. Communications between a user network station and the central network station, as well as between user network stations, can be made in several forms. They can be real-time communications, also known as in-session communications, they can be made by asynchronous messaging, or they can be made by asynchronous batch file transmission and processing.

Oftentimes two or more user network stations communicate with one another via the central network station. For example, user network stations 114 and 116 communicate with one another via communication links 134 and 136, with the communications traveling through the central network station 102. The communications between user network stations are often the basis of the financial transactions and/or services performed or facilitated by the central network station 102. These communications include purchase agreements, investment agreements, as well as other agreements relating to financial matters. It should also be noted that communications between network users not made via user network stations can also be the basis of the financial transactions and/or services performed or facilitated by the central network station 102. Network users include, but are not limited to, individuals, businesses, educational institutions, and other organizations.

FIG. 2B is a further depiction of the conventional electronic financial service network 100 of FIG. 2A. FIG. 2B shows additional participants often found in conventional electronic financial service networks, as well as communication links between and among the additional and prior depicted network participants. It should be understood that not all conventional electronic financial service networks include each of the types of participants depicted in FIG. 2B. Furthermore, not all electronic financial service networks provide the same services. The exemplary electronic financial service network 100 includes a consumer service provider 150 (CSP), a postal service 152, a biller service provider 154 (BSP), additional user network stations, multiple biller network stations 156, and a seller network station 158. It will be appreciated that a biller and a seller are each network users. Furthermore, network stations associated with billers and sellers are, for clarity, labeled biller network stations and seller network stations to highlight their associated network user's roles in the electronic financial service network 100. It also will be appreciated that a given network user could have multiple roles. That is, a biller could also be a payer, and so on.

As used herein, a biller is typically a merchant or an entity that provides a good or service to a consumer. A biller service provider is an entity that provides a biller with a service to allow the biller to receive bill payments. In some cases, a biller can also serve as a biller service provider for themselves or other billers. Accordingly, as used herein, in at least some cases the biller and the biller service provider can be the same entity. As used herein, generally stated, a payee is an individual or entity that receives or is intended to be the ultimate recipient, of some form of payment. Accordingly, a biller is often a payee (and a seller may be a payee, though often a biller is not a seller). Furthermore, a payee may be a biller, whether through the mechanism of a formally presented bill or an informal request for payment. In a similar manner, a consumer may be, but not always is, a payor.

A consumer service provider 150 provides interface access to the central network station 102, and thus network 100, for some network users. A bank or other financial or investment institution is often a consumer service provider (“CSP”). A CSP is also known as a portal. Additionally, a CSP can also offer services to a network user beyond those offered by the central network station 102. Oftentimes the central network station 102 operates behind the scenes in relation to CSP 150. That is, the central network station 102 provides the functionality to provide and/or facilitate financial transactions and/or services, while CSP 150 controls the presentation of such functionality to a network user.

Billers, who access network 100 through biller network stations 156, often electronically present their customer's bills or invoices for services rendered and/or products sold. The central network station 102 typically receives billing information from billers and then presents either summary or complete billing information to payers. Billers also often receive remittance advice via network 100 for payment of bills, both those presented via network 100, and those only paid via network 100. A biller's access to the central network station 102 is sometimes through a BSP 154 which processes bills for several billers.

The FI 120, introduced above, provides access to at least one financial institution network, including the Automated Clearing House (ACH) network or FEDWIRE network, for financial transactions performed or facilitated by the central network station 102. FI 120 also hosts at least one deposit account associated with network 100. The financial institution also provides other services for the network 100, including settlement and treasury functions. As shown in FIG. 2B, central network station 102 also directly accesses other type financial networks. These networks include credit card networks and ATM/POS networks.

A postal service 152 performs delivery of goods purchased by network users and tracks the movement of these goods. This service could be provided in concert with central network station 102. A postal service is a participant in payment-on-delivery transactions.

Introduced above, the central network station 102 causes movement of funds between and among deposit accounts. These movements of funds are either by paper movement or electronic movement. Paper movement of funds includes checks and drafts prepared under the direction of the central network station 102. These checks or drafts are drawn on an account associated with the central network station 102 and payable to a payee designated by a network user. Or, these checks or drafts may be drawn on an account maintained at a financial institution associated with a network user and payable to a payee designated by a network user or deposited into an account associated with the central network station 102.

Electronic movement of funds is also by direction of the central network station 102. As introduced above, the central network station 102 is associated with a financial institution 120 that performs electronic movement of funds on behalf of the central network station 102. Like paper movement of funds, electronic movement of funds may originate from an account associated with the central network station 102, or may originate from an account associated with a network user. A network user must provide account information to the central network station 102 so that the central network station 102 can access that network user's account, whether the access is electronic or paper.

Some electronic financial service networks are closed systems. In a closed system, funds only move among and between individuals or entities that have a pre-established relationship with the central network station of the respective network. Additionally, information typically flows exclusively electronically in closed systems. Individuals and entities with pre-established relationships with a central network station are known as registered users. In these closed systems, funds can move either electronically or by paper, though preferably electronically. Other electronic financial service networks are open systems. In an open system, funds can move not only among and between registered users, but also to unregistered recipients. For movement to an unregistered recipient, funds must move by paper methods, as a central network station directing the transaction does not have access to the recipient's account.

It will be recognized by one skilled in the art that electronic movement of funds is more efficient than paper movement of funds. This efficiency arises because of at least two reasons. First, the cost per transaction is less for electronic movement than paper movement. Second, electronic movements require less time to complete than paper movements. Likewise, it will be recognized that electronic movement of information is also more efficient than paper movement of information.

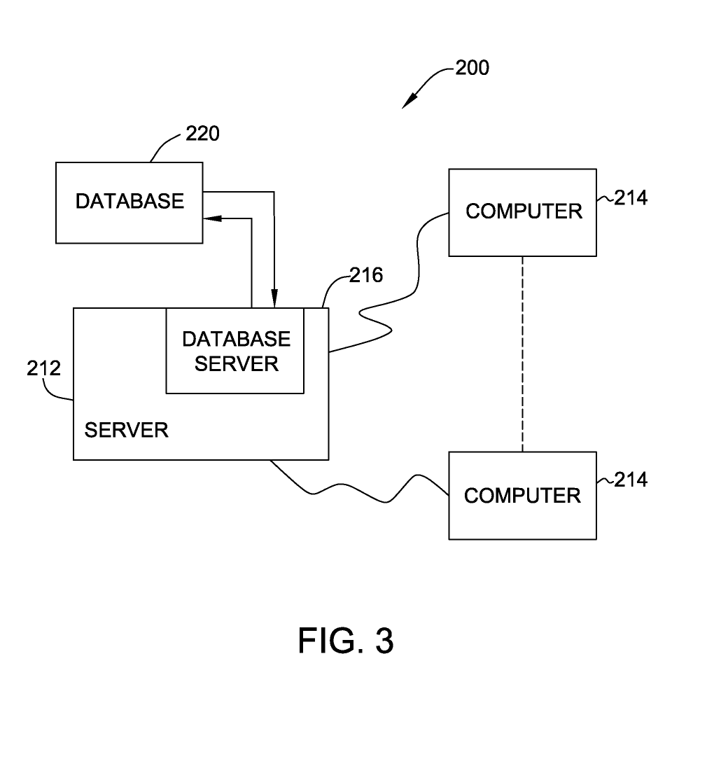

FIG. 3 is a simplified block diagram of an exemplary payment system 200 in accordance with one embodiment of the present invention. In one embodiment, payment system 200 is similar to the electronic financial service network 100 shown in FIGS. 2A and 2B with certain enhancements directed to the electronic processing of financial transactions using as identification for one or both of a payor and a payee, telephone number data, particularly mobile phone number data, in order to affect payment of a bill. More specifically, in the example embodiment, payment system 200 includes a server system 212, and a plurality of client sub-systems, also referred to as client systems 214, connected to server system 212. In one embodiment, client systems 214 are computers including a web browser, such that server system 212 is accessible to client systems 214 using the Internet. Client systems 214 are interconnected to the Internet through many interfaces including a network, such as a local area network (LAN) or a wide area network (WAN), dial-in-connections, cable modems and special high-speed ISDN lines. Client systems 214 could be any device capable of interconnecting to the Internet including a web-based phone, personal digital assistant (PDA), or other web-based connectable equipment. A database server 216 is connected to a database 220 containing information on a variety of matters, as described below in greater detail. In one embodiment, centralized database 220 is stored on server system 212 and can be accessed by potential users at one of client systems 214 by logging onto server system 212 through one of client systems 214. In an alternative embodiment, database 220 is stored remotely from server system 212 and may be non-centralized.

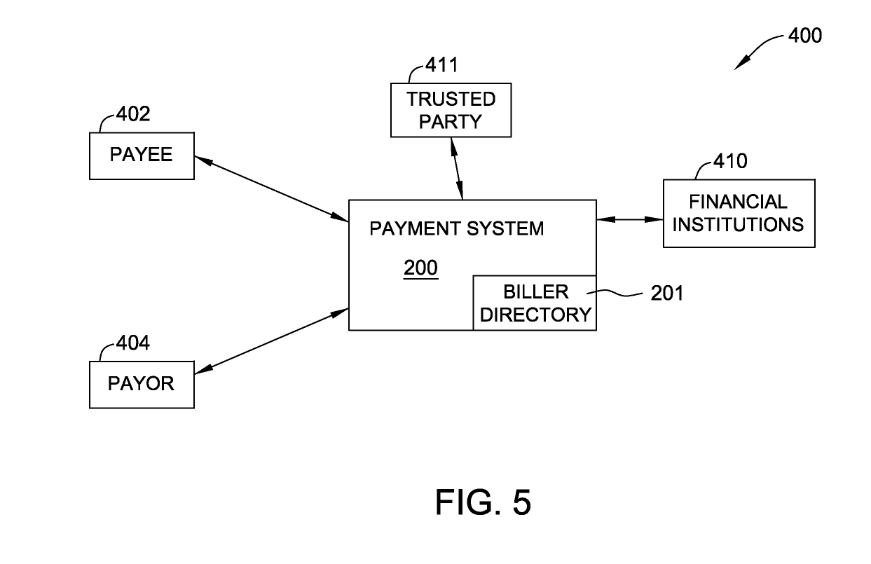

As discussed below, a biller directory 201 (shown in FIG. 5) and/or other consumer related data including data utilized and processed by billers can be stored within database 220. For example, the biller directory 201 may include a list of billers registered to receive payments electronically, a format or structure of consumer account related information that is acceptable for each biller (also referred to herein as an account mask or billing account structure) for processing payments electronically, exception masks associated with the registered billers if required by the particular biller, a list of consumer accounts that are registered for electronic processing of payments, and other consumer related information such as names of the consumers, addresses and telephone numbers, other consumer identifiers, account numbers and payment histories. Other data may also be stored within database 220. In addition, similar data or other billing and consumer related data may also be stored within other databases such as a database associated with billers and/or a database associated with originators.

The embodiments illustrated and described herein as well as embodiments not specifically described herein but within the scope of aspects of the invention constitute exemplary means for the electronic processing of financial transactions. For example, the server system 212 or the client system 214, or any other similar computer device, programmed with computer-executable instructions illustrated in FIG. 3 constitutes exemplary means for the electronic processing of financial transactions in order to affect payment of a bill.

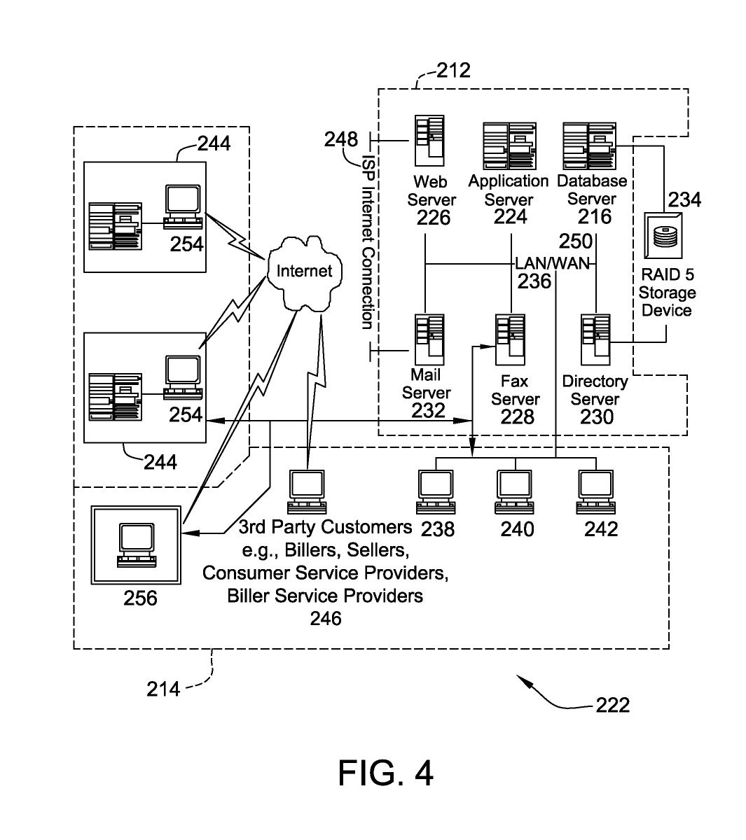

FIG. 4 is an expanded block diagram of an exemplary embodiment of a server architecture of a payment system 222 in accordance with one embodiment of the present invention. Components in system 222, identical to components of system 200 (shown in FIG. 3), are identified in FIG. 4 using the same reference numerals as used in FIG. 3. System 222 includes server system 212 and client systems 214. Server system 212 further includes database server 216, an application server 224, a web server 226, a fax server 228, a directory server 230, and a mail server 232. A disk storage unit 234 is coupled to database server 216 and directory server 230. Servers 216, 224, 226, 228, 230, and 232 are coupled in a local area network (LAN) 236. In addition, a system administrator's workstation 238, a user workstation 240, and a supervisor's workstation 242 are coupled to LAN 236. Alternatively, workstations 238, 240, and 242 are coupled to LAN 236 using an Internet link or are connected through an intranet.

Each workstation, 238, 240, and 242 is a personal computer having a web browser. Although the functions performed at the workstations typically are illustrated as being performed at respective workstations 238, 240, and 242, such functions can be performed at one of many personal computers coupled to LAN 236. Workstations 238, 240, and 242 are illustrated as being associated with separate functions only to facilitate an understanding of the different types of functions that can be performed by individuals having access to LAN 236.

Server system 212 is configured to be communicatively coupled to various individuals, including employees 244 and to third parties, e.g., billers, sellers, biller service providers and/or consumer service providers, 246 using an ISP Internet connection 248. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 250, local area network 236 could be used in place of WAN 250.

In the exemplary embodiment, any authorized individual having a workstation 254 can access system 222. At least one of the client systems includes a manager workstation 256 located at a remote location. Workstations 254 and 256 are personal computers having a web browser. Also, workstations 254 and 256 are configured to communicate with server system 212. Furthermore, fax server 228 communicates with remotely located client systems, including a client system 256 using a telephone link. Fax server 228 is configured to communicate with other client systems 238, 240, and 242 as well.

As used herein, an originator includes any entity providing a consumer with a service to facilitate on-line bill payment. For example, an originator may include a financial institution such as a bank or a third-party entity used by a bank for processing on-line payments for consumers. An originator may also include or be referred to as a consumer service provider (CSP). The originator is typically any entity that provides a consumer with a service to facilitate on-line bill payment. A biller is typically a merchant or an entity that provides a good or service to a consumer. A biller service provider is an entity that provides a biller with a service to allow the biller to receive bill payments. In some cases, a biller can also serve as a biller service provider for themselves or other billers. Accordingly, as used herein, in at least some cases the biller and the biller service provider can be the same entity.

FIG. 5 is a simplified block diagram of an environment 400 in which method 300 is implemented. Environment 400 includes payee 402 and payor 404, both of which are connected (or connectable) to payment system 200, either directly or indirectly, through any of the mechanisms illustrated in FIGS. 3-4 as described herein. Payee 402 will have associated with it at least one payment receiving account (or “payee account”), into which payment from payor 404 will be deposited or credited. Associated with the payee account will be a payee account identifier (such as an account number, transaction card number, etc.) Payor 404 will have associated with it at least one payment generating account (or “payor account”) from which the funds representing the payment to payee 402 will be debited or charged and transferred to the payee account. Payment system 200 preferably additionally communicates with financial institution(s) 410, using the interchange systems as described herein.

In an alternative embodiment, some or all of the tasks described above as being performed by the originator, the biller service provider and/or the biller are performed by payment system 200. For example, in an alternative embodiment, the originators and billers opting to use the payment system are stored within payment system 200.

In at least some known electronic bill payment systems, payments are originated by a bill payment service provider, which is also known as an originator. These payments are fulfilled either via an electronic transaction or via a paper check. The determination of whether a bill payment is fulfilled electronically or via check is based on the data the consumer enters for the payment. If the data entered matches billing data (account masks, remittance address, and check digit routine) provided by a biller and are reflected on a biller directory 201 provided to the bill payment service provider, then the payment can be fulfilled electronically by the bill payment service provider (originator). If the data entered by the consumer does not match the billing data provided by the biller and stored on the biller directory 201, an originator will have to create a paper check containing the consumer entered data for the payment method. The paper check is then provided to the biller or the biller's service provider.

In the example embodiment, a biller directory 201 contains a list of electronic billers (or payees) and their accompanying payment data, or account identifier(s). The payment account identifier is, for example, a credit card account number identifying an account to which funds representing a payment from a payor 404 will be credited. Biller directory 201 also contains a list of payee identifiers, which are associated with payment account identifiers and their respective payment (payee) accounts. No payee identifier is associated with more than one payee or payee account. Each payee identifier includes at least one telephone number associated with a specific payee. In an exemplary embodiment, the telephone number is a mobile telephone number associated with the payee.

Payee 402 may have multiple payee accounts and multiple telephone numbers enrolled in biller directory 201. Payee 402, at the time of enrollment, for example, establishes a default mapping of the multiple telephone numbers to the multiple payee accounts. For example, a payee may have five (5) telephone numbers (1-5) and three (3) payment accounts (A-C) enrolled in biller directory 201. In this example, the payee at the time of enrollment, maps phone 1 to account A, phone 2 to account B, and phone 3 to account C. At a later time, the payee may map phone 4 to, e.g., account A. However, the payee may not map the same phone to two separate accounts. In the exemplary embodiment, the payee accomplishes this mapping through an originator (as described above) website, through which the information in biller directory 201 is updated.

In the exemplary embodiment, payment system 200 includes further enrollment options for payee 402. For example, payee 402 enrolls a trusted third party 411 to supply payee information. Exemplary trusted parties 411 include, but are not limited to, such entities such as a mobile operator, a telecommunications company, and/or an internet service provider.

If the payment data provided by the originator meets the data requirements outlined in the biller directory 201, Payment system 200 will process, route and settle the payment electronically. The biller directory 201 is stored on payment system 200. Specifically, the biller directory 201 is stored on database 220. In one embodiment, the biller directory 201 is downloaded from payment system 200 to a computer system associated with the originator. In another embodiment, the biller directory 201 is stored at payment system 200 and the originator system retrieves information from the biller directory 201 as needed.

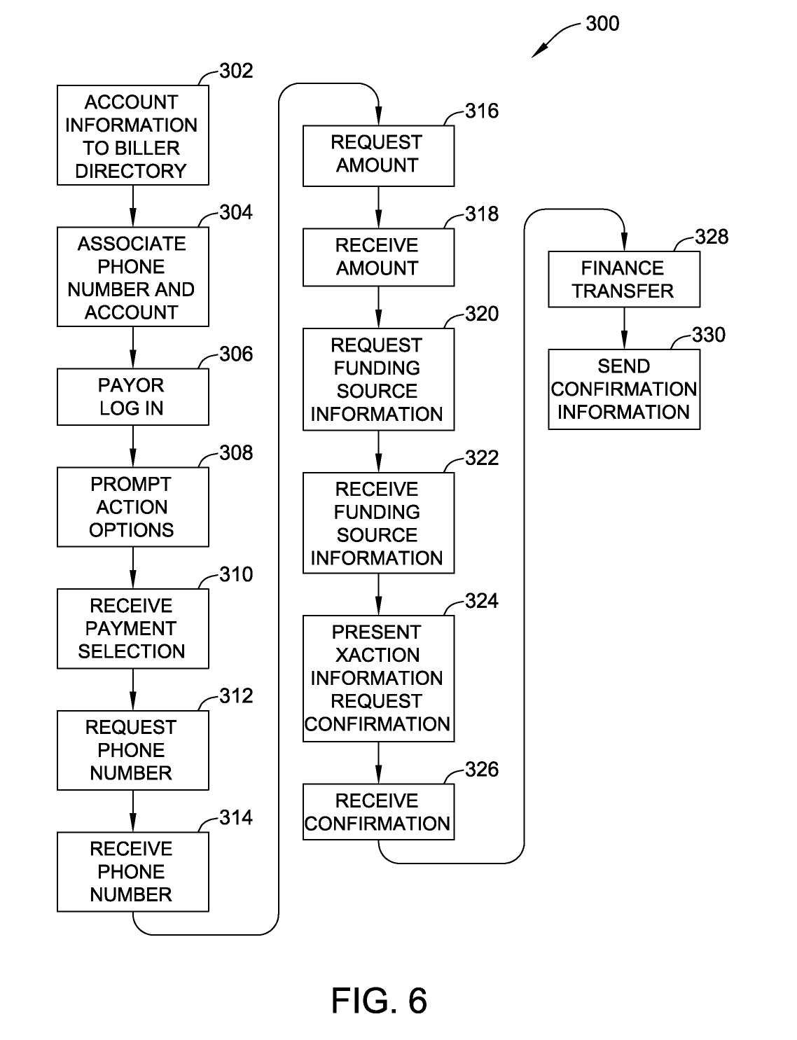

FIG. 6 illustrates an exemplary method 300 for facilitating person-to-person payments using payment system 200. System 200 receives 302 payee identifier information and payee account identifier information regarding payee 402, and stores that information in a biller directory 201. In one exemplary embodiment, the payee account identifier and payee identifier for payee 402 may be supplied to biller directory 201 by payee 402, following payee 402 login to their own banking or bill payment service website. As described above, biller directory 201 may be maintained in database 220 (shown in FIG. 3). Specifically, payee 402 provides to payment system 200 a telephone number which payee 402 desires Payment system 200 to use as an identifier. In the exemplary embodiment, payee 402 is an individual or small business owner. In an embodiment, payee 402 has a pre-existing relationship with the entity operating payment system 200, and is simply adding the telephone number to their account with payment system 200. Alternatively, payee 402 is a new subscriber to payment system 200. In an alternative exemplary embodiment, the account information for payee 402 may be supplied by payor 404, following payor 404 login to their own banking or bill payment service website.

Payment system 200 creates 304 an association between the phone number designated by payee 402, and the payment receiving account information provided by payee 402, for the account to which payments will be applied. In one embodiment, the payee account associated with payee 402 is a transaction card account, such as a credit card account associated with a bank (which is payee 402's bank, as described above, or another bank), or a debit card account. In other embodiments, the payment receiving account is associated with a transaction card associated with a commercial entity, such as a retail store. In another alternative embodiment, the payment receiving account associated with payee 402 is a bank account such as a checking or savings account.

Payment system 200, in an exemplary embodiment, associates a single phone number, or other payee identifier, with a single account. In an alternative exemplary embodiment, payment system 200 is configured to associate a single phone number with a plurality of accounts. In the latter configuration, system 200 is configured, at the instruction of payee 402 or payor 404, to present payor 404, at the time of making a payment, with a selection of accounts. Payor 404 selects the account to which payment is to be made, from amongst the accounts presented.

In order to apply a payment, payor 404 logs in 306, either directly into payment system 200, or into payor 404's own banking website, credit card website, etc., which, in turn, is either connected to, or part of, payment system 200. Payor 404 enters biller directory 201, either as a subscriber or a one-time user. Steps 308-318 collectively represent payee 402 making a request to payment system 200 for a payment (transfer of funds). Specifically, payment system 200 prompts 308 payor 404 to take an action, such as make a payment, transfer funds or take other similar action. System 200 receives 310 payor 404's selection of the payment option and requests 312 that payor 404 provide the payee identifier which, in the exemplary embodiment, includes the option to enter only a telephone number, specifically a mobile telephone number. System 200 receives 314 the payee identifier, which, in the exemplary embodiment, is the phone number previously provided by payee 402 to payor 404. Upon receipt of the telephone number, Payment system 200, using the previously-created association, identifies the account belonging to payee 402 into which the funds will be transferred. Payment system 200 further prompts 316 payor 404 to, for example, fill in a box with the amount to be transferred (“transfer amount”). Upon receipt 318 of the amount to be transferred, system 200 requests 320 an indication of the funding source (i.e., the account or accounts associated with payor 404) from which the funds will be transferred. Payor 404's transfer account is an account associated with a transaction card, such as a credit card or debit card. Alternatively, payor 404's transfer account is a checking or savings account, or other type of account.

After system 200 receives 322 the requested payment method information, system 200 presents 324 the details of the transaction to payor 404 and requests confirmation of the transaction, such as through payor 404 clicking on an onscreen “submit” button or the like. Upon receipt 326 of payor 404's confirmation of the transaction, system 200 finalizes 328 the transfer of funds from payor 404 to payee 402, and transmits 330 to either payor 404, payee 402, or both, a confirmation of the completion of the transfer, such as by an email message.

The systems and processes are not limited to the specific embodiments described herein. In addition, components of each system and each process can be practiced independent and separate from other components and processes described herein. Each component and process also can be used in combination with other assembly packages and processes.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense. For example, the example embodiments described herein relate to electronic bill payment between two individuals. In an alternative embodiment, at least one of the individuals is a sole proprietor businessman, wherein the payment comprises the completion of a commercial transaction. Accordingly, as described herein an individual includes both a private person and a sole proprietor, and the systems and processes described herein can be used in an informal person-to-person private transfer of funds and in a commercial transaction.

While the invention has been described in terms of various specific embodiments, those skilled in the art will recognize that the invention can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof, wherein the technical effect is receiving a payee input file, determining whether each payee in the payee input file matches a biller in a biller database, and outputting an output file that indicates whether each payee was matched to a biller. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of methods and systems of transacting person-to-person payments provide a simplified alternative mechanism for identifying a payee, but without necessarily providing a payor any information regarding any of payee's financial, banking or credit details. As a result, the methods and systems described herein facilitate maximizing electronic payments by identifying payees capable of receiving electronic payments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for facilitating person-to-person electronic payments from a payor to a payee account associated with a payee, the method implemented using a computer device coupled to a memory device, the method comprising:
storing in the memory device a payee account identifier and a payee identifier associated therewith, the payee account identifier identifying the payee account, the payee identifier including a telephone number associated with the payee;
receiving from the payor a request for a transfer of funds from an account associated with the payor to the payee, wherein the request includes a transfer amount and the payee telephone number;
using the payee telephone number received from the payor and the computer device to retrieve the payee account identifier from the memory device; and
electronically transferring the transfer amount from the payor account to the payee account identified by the payee account identifier, thereby completing the transfer of the funds.

2. The method in accordance with claim 1 wherein the telephone number is a mobile telephone number associated with only one payee account.

3. The method in accordance with claim 1 wherein storing in the memory device a payee account identifier and a payee identifier associated therewith further comprises directly linking a preexisting payee account identifier with the payee telephone number.

4. (canceled)

5. The method in accordance with claim 1 wherein the payee account further comprises a plurality of payee accounts, and wherein storing in the memory device a payee account identifier and a payee identifier associated therewith further comprises:
storing a plurality of payee account identifiers corresponding to the plurality of payee accounts, each payee account identifier associated with a corresponding payee account; and
storing a discrete payee identifier associated with a respective one of each of the plurality of payee accounts, each discrete payee identifier being a unique telephone number associated with the payee.

6. The method in accordance with claim 1 wherein the payee account is a credit card account, and wherein electronically transferring the transfer amount further comprises electronically transferring the transfer amount from the payor account to the payee account.

7. The method in accordance with claim 1 wherein the computer device is in communication with an interchange network, and wherein electronically transferring the transfer amount further comprises electronically transferring the transfer amount via the interchange network from the payor account to the payee account, the payor account being associated with a payor payment card, and the payee account being associated with a payee payment card.

8. The method in accordance with claim 1 wherein the payee identifier includes the payee telephone number and a name of the payee, and wherein the method further comprises:
using the payee telephone number received from the payor to retrieve the payee account identifier and the payee name from the memory device; and
transmitting the payee name without transmitting the payee account identifier to a payor computing device for displaying the payee name on the payor computing device such that the payor can confirm a person-to-person electronic payment prior to electronically transferring the transfer amount from the payor account to the payee account.

9. A computer system for facilitating person-to-person electronic payments from a payor to a payee account associated with a payee, comprising:
a memory device;
a processor; and
a computer-readable storage device having encoded thereon computer-executable instructions that are executable by the processor to perform functions comprising:
storing in the memory device a payee account identifier and a payee identifier associated therewith, the payee account identifier identifying the payee account, the payee identifier including a telephone number associated with the payee;
receiving from the payor a request for a transfer of funds from an account associated with the payor to the payee, wherein the request includes a transfer amount and the payee telephone number;
using the payee telephone number received from the payor and the computer system to retrieve the payee account identifier from the memory device; and
electronically transferring the transfer amount from the payor account to the payee account identified by the payee account identifier, thereby completing the transfer.

10. The computer system in accordance with claim 9 wherein the telephone number is a mobile telephone number associated with only one Payee account.

11. The computer system in accordance with claim 9 wherein computer-executable instructions cause the processor to directly link a preexisting payee account identifier with the payee telephone number.

12. (canceled)

13. The computer system in accordance with claim 9 wherein the payee account further comprises a plurality of payee accounts, and wherein the computer-executable instructions cause the processor to:
store a plurality of payee account identifiers corresponding to the plurality of payee accounts, each payee account identifier associated with a corresponding payee account; and
store a discrete payee identifier associated with a respective one of each of the plurality of payee accounts, each discrete payee identifier being a unique telephone number associated with the payee.

14. The computer system in accordance with claim 9 wherein the one payee account is a credit card account, and wherein electronically transferring the transfer amount further comprises electronically transferring the transfer amount from the payor account to the payee account.

15. The computer system in accordance with claim 9 wherein the computer device is in communication with an interchange network, and wherein electronically transferring the transfer amount further comprises electronically transferring the transfer amount via the interchange network from the payor account to the payee account, the payor account being associated with a payor payment card, and the payee account being associated with a payee payment card.

16. The computer system in accordance with claim 9 wherein the payee identifier includes the payee telephone number and a name of the payee, and wherein the computer-executable instructions further cause the processor to:
use the payee telephone number received from the payor to retrieve the payee account identifier and the payee name from the memory device; and
transmit the payee name without transmitting the payee account identifier to a payor computing device for displaying the payee name on the payor computing device such that the payor can confirm a person-to-person electronic payment prior to electronically transferring the transfer amount from the payor account to the payee account.

17. One or more computer-readable storage media having computer-executable instructions embodied thereon for facilitating person-to-person electronic payments from a payor to a payee account associated with a payee, wherein, when executed by at least one processor, the computer-executable instructions cause the processor to:
store in the memory device a payee account identifier and a payee identifier associated therewith, the payee account identifier identifying the payee account, the payee identifier including a telephone number associated with the payee;
receive from the payor a request for a transfer of funds from an account associated with the payor to the payee, wherein the request includes a transfer amount and the payee telephone number;
using the payee telephone number received from the payor and the processor to retrieve the payee account identifier from the memory device; and
electronically transfer the transfer amount from the payor account to the payee account identified by the payee account identifier, thereby completing the transfer.

18. The computer-readable storage media in accordance with claim 17 wherein the telephone number is a mobile telephone number associated with only one payee account.

19. The computer-readable storage media in accordance with claim 17 wherein the computer-executable instructions cause the processor to directly linking a preexisting payee account identifier with the payee telephone number.

20. (canceled)

21. The computer-readable storage media in accordance with claim 17 wherein the payee account further comprises a plurality of payee accounts, and wherein the computer-executable instructions cause the processor to:
store a plurality of payee account identifiers corresponding to the plurality of payee accounts, each payee account identifier associated with a corresponding payee account, and
store a discrete payee identifier associated with a respective one of each of the plurality of payee accounts, each discrete payee identifier being a unique telephone number associated with the payee.

22. The computer-readable storage media in accordance with claim 17 wherein the payee account is a credit card account, and wherein electronically transferring the transfer amount further comprises electronically transferring the transfer amount from the payor account to the payee account.

23. The computer-readable storage media in accordance with claim 17, wherein the processor is in communication with an interchange network, and wherein electronically transferring the transfer amount further comprises electronically transferring the transfer amount via the interchange network from the payor account to the payee account, the payor account being associated with a payor payment card, and the payee account being associated with a payee payment card.

24. The computer-readable storage media in accordance with claim 17 wherein the payee identifier includes the payee telephone number and a name of the payee, and wherein the computer-executable instructions further cause the processor to:
use the payee telephone number received from the payor to retrieve the payee account identifier and the payee name from the memory device; and
transmit the payee name without transmitting the payee account identifier to a payor computing device for displaying the payee name on the payor computing device such that the payor can confirm a person-to-person electronic payment prior to electronically transferring the transfer amount from the payor account to the payee account.

25. The method in accordance with claim 1, wherein storing in the memory device a payee account identifier and a payee identifier associated therewith further comprises storing a payee account identifier that is directly linked with a plurality of telephone numbers.

26. The computer system in accordance with claim 1, wherein computer-executable instructions cause the processor to store, in the memory device, a payee account identifier that is directly linked with a plurality of telephone numbers.

27. The computer-readable storage media in accordance with claim 17, wherein the computer-executable instructions further cause the processor to store a payee account identifier that is directly linked with a plurality of telephone numbers.
